(19) United States
(12) Patent Application Publication
(10) Pub. No.: US 2026/0336461 A1
(43) Pub. Date: Oct. 29, 2026

(54) System And Method For Integrating Multi-Agent Reinforcement Learning And Consensus-Based Energy Management To Achieve Electric Vehicle Charging Station Placement

(71) Applicant: MING CHUAN UNIVERSITY, TAIPEI (TW)

(72) Inventor: DAVID CHUNHU LI, TAOYUAN COUNTY (TW)

(21) Appl. No.: 19/456,469

(22) Filed: Jan. 22, 2026

(30) Foreign Application Priority Data
Apr. 28, 2025 (TW) 114115991

(51) Int. Cl. B60L 53/67; G06N 3/0442; G06N 3/0464; G06N 3/092

(52) U.S. Cl. CPC B60L 53/67; G06N 3/0442; G06N 3/0464; G06N 3/092

(57) ABSTRACT

A system and method for integrating multi-agent reinforcement learning and consensus-based energy management to achieve smart electric vehicle charging station placement. The method includes a first agent that combines LSTM and CNN models to predict temporal and spatial charging demand distribution. A second agent uses MILP to output energy allocation strategies based on charging demand, station capacity, grid load, renewable energy, and pricing. A third agent has reinforcement learning models to generate optimal station location layouts. A fourth agent coordinates and balances outputs from the first three agents. The system and method optimize charging station layout and energy distribution by considering real-time factors including demand forecasting, grid load, and energy costs. The system and method proactively address EV charging infrastructure challenges, enable effective design and expansion while ensuring stations optimally meet current and future demands, reducing operational costs, and enhancing grid stability for sustainable urban development.

### BACKGROUND OF THE INVENTION

### 1. Fields of the Invention

The present invention relates to a system and method for integrating multi-agent reinforcement learning and consensus-based energy management to achieve electric vehicle charging station placement, and more particularly, to provide a solution that can balance grid demand and ensure stable operation, solve electric vehicle charging station layout and energy distribution problems, while reducing operational costs and enhancing grid stability.

### 2. Descriptions of Related Art

The global trend toward electric vehicle (EV) transition is accelerating rapidly. As governments, industries, and consumers increasingly recognize the environmental and economic benefits of electrification, electric vehicles play a crucial role in reducing greenhouse gas emissions, mitigating climate change, and promoting sustainable urban development. However, the widespread adoption of electric vehicles also brings new challenges, particularly in supporting the infrastructure needed for the growing number of electric vehicle users. Effective and strategic placement of charging stations is a necessary condition for successfully advancing this transition. However, current electric vehicle charging infrastructure often cannot keep pace with continuously growing demand, leading to problems such as congestion, inefficient energy use, and uneven distribution of charging stations.

The rapid proliferation of electric vehicles poses significant challenges for the development of charging infrastructure, particularly in ensuring the efficiency, sustainability, and accessibility of these networks for all users. One of the most prominent challenges is the uneven spatial distribution of charging stations. In many urban areas, charging stations tend to concentrate in high-demand locations, resulting in underserved areas in other regions. This imbalance can lead to congestion at certain sites while other stations have low utilization rates, causing inconvenience and longer waiting times for electric vehicle users. Therefore, there is an urgent need to develop efficient strategies to optimize the layout of new sites and address the relocation or removal of underutilized stations.

Another important challenge is energy management. As electric vehicle integration gradually increases, especially during peak demand periods, energy grids face enormous pressure. This pressure is further exacerbated by the intermittent nature of renewable energy sources (such as solar and wind power). If energy demand and supply cannot be properly managed, electric vehicle integration may lead to inefficiency, higher energy costs, and could even disrupt local grid stability. Therefore, optimizing energy use by matching electric vehicle charging demand with renewable energy supply is essential.

The dynamic nature of electric vehicle charging demand adds complexity to the problem. Charging demand fluctuates based on multiple factors (such as time of day, weather, traffic patterns, and the growth of electric vehicle density in a region). Traditional infrastructure planning methods are often too rigid to adapt to these dynamic conditions, creating an urgent need for a system that can predict demand in real-time, adjust site layouts, and manage energy. Additionally, the success of electric vehicle charging infrastructure depends on collaboration among multiple stakeholders, including charging station operators, energy suppliers, municipal planners, and consumers. Effective collaboration among these entities is crucial for coordinating energy distribution, pricing strategies, and site deployment. Without such collaboration, inefficiency issues will continue to undermine the overall effectiveness of electric vehicle infrastructure.

Prior art proposes a robust optimization model that combines renewable energy sources such as wind and photovoltaic systems along with energy storage systems (ESS) to address the uncertainty of electric vehicle charging demand and renewable energy output. This model employs Gaussian kernel density estimation to avoid overly conservative solutions and introduces load volatility to evaluate the compatibility between renewable energy output and charging demand. By optimizing charging station site selection, renewable energy generation, and storage capacity, this model demonstrates improved economic efficiency and system reliability in simulations while balancing investment and operational costs.

Similarly, other related research studies optimal charging station layouts in radial distribution networks, aiming to minimize energy losses, voltage deviations, and land costs while using the 2m point estimation method (2m PEM) to consider the uncertainty of electric vehicle demand. The research employs differential evolution (DE) algorithms and Harris Hawks optimization (HHO) algorithms to optimize charging station locations, demonstrating the advantages of distributed charging station configurations in improving user accessibility and system performance.

Another existing approach proposes applying data-driven methods for early charging station site selection based on urban data (such as population and travel information), introducing δ-nearest and K-nearest models to maximize citizen satisfaction, and modeling the problem as a submodular maximization task solved using greedy algorithms. Case studies demonstrate the scalability and effectiveness of this method, showing high practical application value.

Existing technology also employs a hybrid optimization method based on genetic algorithm and simulated annealing (GA-SAA) for charging station layout, focusing on minimizing power losses and maintaining network voltage stability with photovoltaic systems. Research indicates that GA-SAA outperforms other techniques, providing a robust solution for enhancing distribution network resilience and optimizing charging station layout.

Additionally, prior art proposes a dynamic pricing-based charging station site selection strategy that combines user behavior and site competition, employing a soft actor-critic (SAC) reinforcement learning algorithm. This method reduces waiting times and balances grid loads by optimizing real-time pricing and charging station layout, demonstrating the advantages of dynamic pricing over fixed pricing models.

Other related patents or research also contribute to the complexity of electric vehicle charging station deployment. For example, genetic algorithms are utilized to solve bi-objective optimization problems, making progress in balancing site deployment costs and user travel distances; or multi-objective evolutionary algorithms (MOEAs) are applied to optimize charging station locations and capacities, focusing on minimizing electric vehicle travel time and the number of sites. Furthermore, hybrid deep learning models are applied to predict variables such as population growth and electric vehicle adoption rates, optimizing charging station and dynamic wireless charging (DWC) layouts. Deep learning-based predictions improve infrastructure layout decisions and reduce costs. Related research also proposes fast charging station deployment solutions based on reinforcement learning frameworks and advanced deep network models, addressing power losses, harmonic distortion, and voltage imbalance issues in distributed generation grid systems.

However, the aforementioned electric vehicle infrastructure planning methods mostly rely on static models, deterministic algorithms, or simple rule-based systems, which cannot cope with the complexity of modern smart cities. Therefore, for the prediction, learning, construction, and cost considerations of electric vehicle charging stations, while simultaneously considering grid operation and stability, innovative solutions are needed that combine spatial optimization, energy management, demand prediction, and multi-party collaboration to ensure that electric vehicle charging networks can meet the demands of a sustainable future.

In view of this, the inventors have devoted themselves to further research on energy management and deployment solutions for electric vehicle charging stations, and have undertaken research and development and improvements, hoping to solve the aforementioned problems with a better invention. After continuous experimentation and modification, the present invention provides a system and method for integrating multi-agent reinforcement learning and consensus-based energy management to achieve electric vehicle charging station placement to eliminate the shortcomings mentioned above.

### SUMMARY OF THE INVENTION

The present invention provides a method for integrating multi-agent reinforcement learning and consensus-based energy management to achieve smart electric vehicle charging station placement, which executes the following steps after being loaded by a device. The steps comprises: through a first agent, which is a hybrid LSTM (Long Short-Term Memory) model and CNN (convolutional neural networks) model, by inputting historical data of at least one electric vehicle charging station to predict temporal and spatial distribution of charging demand; by a second agent, which utilizes MILP (Mixed Integer Linear Programming), based on the charging demand and at least one of the capacity, grid load, renewable energy, or pricing of the electric vehicle charging stations, to output an energy allocation strategy; through a third agent, which is configured with an RL (Reinforcement Learning) model, based on the charging demand, the energy allocation strategy, and the locations of the electric vehicle charging stations, to output a location layout plan for the electric vehicle charging stations; and through a fourth agent, which uses an RL model to interactively coordinate and balance the outputs of the first agent, second agent, and third agent.

The method for integrating multi-agent reinforcement learning and consensus-based energy management to achieve smart electric vehicle charging station placement as described above, wherein the first agent learns spatial features of the charging demand through the CNN model, and analyzes long-term temporal dependencies based on the spatial features of the charging demand through the LSTM model.

The method for integrating multi-agent reinforcement learning and consensus-based energy management to achieve smart electric vehicle charging station placement as described above, wherein the second agent is constrained based on the charging demand and the maximum demand, capacity, grid load, and renewable energy of the electric vehicle charging stations, and outputs the energy allocation strategy through MILP, and the energy allocation strategy satisfies the on/off status of the electric vehicle charging station locations at each time point.

The method for integrating multi-agent reinforcement learning and consensus-based energy management to achieve smart electric vehicle charging station placement as described above, wherein the energy allocation strategy is determined through binary decision variables.

The method for integrating multi-agent reinforcement learning and consensus-based energy management to achieve smart electric vehicle charging station placement as described above, wherein the RL model of the third agent comprises states, actions, rewards, and policies. The state is defined as a system of the locations of the electric vehicle charging stations, the charging demand, and the energy allocation strategy. The action is defined as adding or removing based on the locations of the electric vehicle charging stations. The reward is defined as at least one of location coverage rate, utilization rate, congestion level, waiting time, and construction cost of the electric vehicle charging stations, and defines at least one reward function. Reducing congestion level and waiting time are positive rewards, while reducing coverage rate and increasing the construction cost are negative rewards. The policy is defined as iterative update rules based on the reward function to correspondingly output the location layout plan for the electric vehicle charging stations.

The method for integrating multi-agent reinforcement learning and consensus-based energy management to achieve smart electric vehicle charging station placement as described above, wherein the RL model of the fourth agent takes the outputs of the first through third agents as input values, and defines a consensus protocol to iteratively adjust and minimize the loss functions of the first through third agents, making the outputs of the first through third agents conform to the consensus protocol, to serve as the output of the fourth agent.

The present invention further provides a system for integrating multi-agent reinforcement learning and consensus-based energy management to achieve smart electric vehicle charging station placement, which comprises a device implementing the method for integrating multi-agent reinforcement learning and consensus-based energy management to achieve smart electric vehicle charging station placement as described above, and wherein the electric vehicle charging stations are respectively connected to the device.

From the above description and configuration, it is evident that the present invention has the following advantages and benefits, which are detailed one by one as follows:
1. The present invention establishes multiple agents, such as the first agent using a hybrid LSTM-CNN model to predict the spatiotemporal patterns of electric vehicle charging demand, which is crucial for electric vehicle charging station layout and energy distribution, providing real-time insights that enable the system to proactively adjust its strategies. Combining time series prediction with real-time optimization ensures that the charging network can dynamically respond to constantly changing conditions. The second agent utilizes MILP for efficient energy allocation strategies for electric vehicle charging infrastructure. Through the third and fourth agents, multi-agent reinforcement learning (MARL) is integrated with consensus-based energy management systems, enabling dynamic expansion of solutions. Thereby, each agent in the present invention can be responsible for specific tasks, such as demand prediction, spatial layout optimization, and energy allocation management. These agents learn from the environment and interact with each other, optimizing their decision-making processes over time and utilizing MARL to adapt to changes in demand, grid conditions, and available resources, ensuring efficient operation.
2. The fourth agent of the present invention employs a consensus-based method that ensures the actions of each agent align with the overall system goals. For example, one agent may prioritize reducing charging station congestion, while another agent focuses on reducing energy costs or maximizing renewable energy utilization. Through consensus optimization, the system achieves balance among these competing objectives, ensuring harmonious and efficient operation of the entire charging network.
3. The present invention has significant importance for smart city development and grid stability. As cities gradually achieve electrification and integrate renewable energy, smart energy management solutions will become key to balancing grid demand and ensuring stable operation. By proactively addressing electric vehicle charging station layout and energy distribution problems, it can lay the foundation for a more sustainable electrified future. The importance of the present invention is mainly reflected in the following aspects:
(a) Municipal planners: The present invention can help urban planners more effectively design and expand electric vehicle infrastructure, ensuring that charging stations can optimally meet current and future demands while avoiding excessive burden on local energy grids.
(b) Energy suppliers: The consensus-based energy management framework enables energy suppliers to better balance supply and demand, particularly when integrating renewable energy sources. The present invention can also reduce operational costs and enhance grid stability.
(c) Electric vehicle users: For electric vehicle owners, the present invention will provide a more reliable, convenient, and economical charging experience, reducing the risk of queuing at charging stations and providing more consistent charging facilities in both urban and suburban areas.
(d) Policy makers: The present invention provides valuable insights for policy makers supporting electric vehicle infrastructure expansion, promoting sustainable energy use, and reducing urban congestion, proposing a robust and scalable solution that contributes to future smart city development planning.
4. The system of the present invention possesses multiple benefits for enhancing electric vehicle charging infrastructure efficiency. Through multi-agent reinforcement learning (MARL) and consensus-based energy management technology, it achieves intelligent optimization of charging station spatial distribution, effectively reducing vehicle owner waiting times, improving site utilization rates, and lowering overall operational costs. The present invention can also adjust grid loads in real-time and optimize renewable energy usage, achieving the dual objectives of carbon emission reduction and stable grid operation. It possesses high scalability and adaptability, capable of responding to urban development, energy price fluctuations, and infrastructure changes, providing solutions applicable to various scenarios, and dynamically adjusting charging station layouts and resource allocation through real-time data analysis. Furthermore, the operational and usage insights generated by the present invention can serve as reference for policy formulation and urban planning, assisting in developing smart energy and infrastructure development strategies, and promoting the development of new business models such as dynamic energy pricing and smart grid integration. Overall, the present invention provides cost-effective, environmentally friendly, and sustainable development solutions for smart city construction, with high industrial application potential.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a system architecture diagram of the present invention;

FIG. 2 is a flowchart of the present invention;

FIG. 3 is an action radar chart of the RL optimization for electric vehicle charging station layout of the present invention;

FIG. 4 is an action chart of the RL optimization for 5 electric vehicle charging station layouts of the present invention;

FIG. 5 is an average reward chart in the RL optimization model of the present invention;

FIG. 6 is the average reward in the RL optimization model of the present invention;

FIG. 7 is a convergence behavior chart of three agent parameters in the consensus-based management agent of the present invention;

FIG. 8 is a chart showing the influence of learning rate (a) and penalty term (p) on consensus of the present invention;

FIG. 9 is a chart of final consensus values achieved by changing learning rate (a) and penalty term (p) of the present invention;

FIG. 10 is the improvement rate of reduced waiting time after optimizing electric vehicle charging station layout of the present invention;

FIG. 11 is a comparison chart of electric vehicle charging waiting times before and after optimization of charging station;

FIG. 12 is the impact of the multi-agent optimization method of the present invention on reducing waiting times for 60 charging stations;

FIG. 13 is a comparison chart of utilization rates before and after electric vehicle charging station optimization of the present invention;

FIG. 14 is a utilization rate improvement chart for electric vehicle charging stations after layout optimization of the present invention;

FIG. 15 is a load balancing comparison chart for electric vehicle charging stations with and without MAS optimization of the present invention;

FIG. 16 is an energy demand comparison chart for each electric vehicle charging station with and without MAS optimization allocation of the present invention;

FIG. 17 is a statistical analysis comparison chart of energy demand for each electric vehicle charging station with and without MAS optimization of the present invention, and

FIG. 18 is an experimental result chart of enhanced spatial coverage of electric vehicle charging stations through MAS optimization of the present invention.

### DETAILED DESCRIPTION OF THE PREFERRED EMBODIMENT

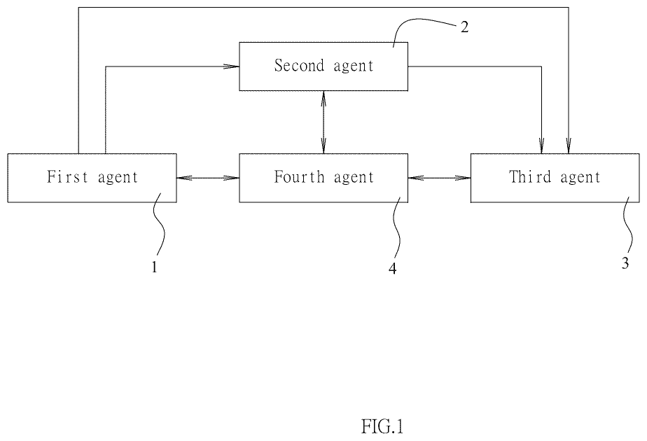

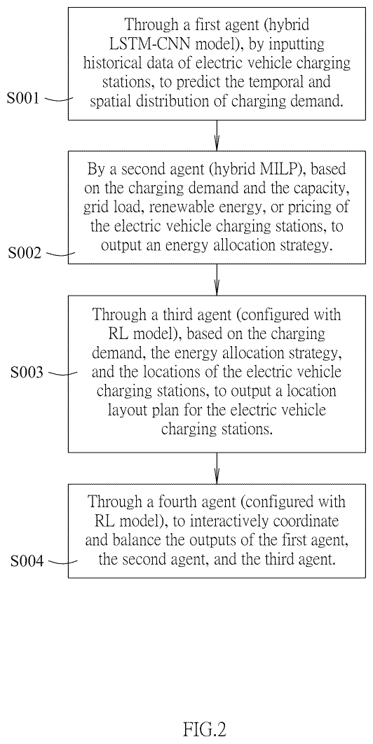

Please refer to FIGS. 1 and 2, the present invention is a method for integrating multi-agent reinforcement learning and consensus-based energy management to achieve smart electric vehicle charging station placement. The present invention configures a multi-agent system (MAS) by setting up a first agent, a second agent, a third agent, and a fourth agent. The present invention defines system optimization objectives, which include minimizing waiting time, balancing energy use, and optimizing the spatial distribution of charging stations.

### [Objective 1] Minimize Waiting Time:

The objective is to minimize the total waiting time across all charging stations and time intervals. This objective can be expressed by the following mathematical formula 1:

$$f ( {x}_{1} ) = min ( {\sum }_{i = 1}^{N} {\sum }_{j = 1}^{M} {w}_{ij} \cdot {d}_{ij} ) \qquad [ Mathematical Formula 1 ]$$

Where N represents the total number of charging stations, M represents the total number of time intervals (for example, hours in a day or days in a week), Wᵢⱼ represents the waiting time at charging station i during time interval j; dᵢⱼ represents the electric vehicle charging demand at charging station i during time interval j. Wᵢⱼ·dᵢⱼ represents the contribution of charging station i during time interval j to the total waiting time, weighted according to the demand during that time.

### [Objective 2] Balance Energy Use:

This involves minimizing the deviation between each charging station's energy consumption and the average energy consumption within that time interval. By reducing this deviation, the system can more evenly distribute energy use, thereby reducing peak loads and promoting efficient utilization of energy resources (especially renewable energy). This objective ensures balanced energy consumption within the charging network, avoiding grid overload and maximizing the use of available energy resources. It can be expressed by the following mathematical formula 2:

$$f ( {x}_{2} ) = min ( {\sum }_{i = 1}^{N} {\sum }_{j = 1}^{M} \vert {E}_{ij} \cdot {\overline{E}}_{j} \vert ) \qquad [ Mathematical Formula 2 ]$$

Where Eᵢⱼ represents the energy consumption of charging station i during time interval j, and Ēⱼ represents the average energy consumption of all charging stations during time interval j. [Objective 3] Optimize Spatial Distribution:

This involves minimizing the sum of weighted distances between charging stations and user locations, aiming to strategically position charging stations to maximize coverage and accessibility while minimizing the distance electric vehicle users need to travel to charging stations. Its expression can be shown in the following mathematical formula 3:

$$f ( {x}_{3} ) = min ( {\sum }_{i = 1}^{N} {\sum }_{k = 1}^{P} {p}_{k} \cdot d ( {C}_{i} , {U}_{k} ) ) \qquad [ Mathematical Formula 3 ]$$

Where P represents the total number of user locations (such as residential areas, workplaces, etc.), pk represents the importance weight of user location k, Cᵢ represents the location of charging station i, Uₖ represents user location k, and d(Cᵢ, Uₖ) represents the distance between charging station i and user location k. This objective aims to position charging stations in locations most convenient for users to reach, thereby reducing travel time and enhancing user convenience.

Comprehensive objective function: The aforementioned three objectives can be combined into a multi-objective optimization function, thereby enabling the system to balance according to the relative importance of each objective, which can be expressed as shown in the following mathematical formula 4:

min F=α·f(x₁)+β·f(x₂)+γ·f(x₃) [Mathematical Formula 4]

Where α, β, and γ are weight coefficients used to determine the relative importance of minimizing waiting time, balancing energy use, and optimizing spatial distribution. This comprehensive objective function aggregates the three main objectives into one optimization problem, and the weight coefficients can be adjusted according to the system's priorities. For example, if minimizing waiting time is more important than balancing energy use, then a can be assigned a higher weight value.

Thereby, the present invention is based on the aforementioned objectives to complete the development of each agent, enabling their models to operate independently and complete their tasks. The present invention is a method for integrating multi-agent reinforcement learning and consensus-based energy management to achieve smart electric vehicle charging station placement, which executes the following steps after being loaded by a device, the steps comprising:
S001: Through a first agent, which is a hybrid LSTM (Long Short-Term Memory) model and CNN (convolutional neural networks) model, by inputting historical data of at least one electric vehicle charging station to predict temporal and spatial distribution of charging demand;
Where the first agent is mainly configured as a demand prediction agent, primarily predicting future electric vehicle charging demand based on historical data, traffic patterns, and other relevant factors. It employs a hybrid LSTM-CNN model for time series prediction, generating spatiotemporal demand prediction results, with the output being predictions of spatial and temporal distribution of charging demand;
The demand prediction agent utilizes a hybrid LSTM-CNN model to predict the spatiotemporal distribution of electric vehicle charging demand.

In one embodiment, the first agent learns spatial features of the charging demand through the CNN model, and analyzes long-term temporal dependencies based on the spatial features of the charging demand through the LSTM model. By combining CNN and LSTM, prediction accuracy is improved through spatial patterns and time series features in the data. The CNN is responsible for learning local spatial features, while the LSTM captures long-term temporal dependencies in the charging demand data. This combination effectively enhances prediction performance. The formula definition of the hybrid LSTM-CNN model is as follows:

Let Xₜ=[x1, x2, . . . , xn] represent the charging demand input sequence at time t, where xi is the charging demand of charging station i. The CNN component extracts spatial features from Xₜ, and its convolution operation can be expressed by the following mathematical formula 5:

Cₜ=f(W_{c}*Xₜ+b_{c}) [Mathematical Formula 5]

Where W_{c} represents the weights of the convolution filter, be is the bias term, * represents the convolution operation, and f(⋅) is the activation function (such as ReLU).

The LSTM component processes the spatial features extracted by the CNN to capture temporal dependencies in the charging demand data. The LSTM update equations are shown in the following mathematical formulas 6 to 10:

iₜ=σ(Wᵢ·[Cₜ,hₜ₋₁]+bᵢ) [Mathematical Formula 6]

fₜ=σ(W_{f}·[Cₜ,hₜ₋₁]+b_{f}) [Mathematical Formula 7]

σₜ=σ(Wₒ·[Cₜ,hₜ₋₁]|+bₒ) [Mathematical Formula 8]

cₜ=fₜ·cₜ₋₁+iₜ·tan h(W_{c}·[Cₜ,hₜ₋₁]+b_{c}) [Mathematical Formula 9]

hₜ=σₜ·tan h(cₜ) [Mathematical Formula 10]

Where: iₜ, fₜ, o_{f} are the input gate, forget gate, and output gate respectively, cₜ is the cell state, hₜ is the hidden state, Wᵢ, W_{f}, Wₒ, W_{c} are learnable parameters, σ(⋅) represents the sigmoid activation function, and tanh(⋅) represents the hyperbolic tangent function;

The final output of the hybrid LSTM-CNN model is the predicted charging demand Yₜ, whose formula is shown in the following mathematical formula 11:

Ŷₜ=W_{y}·hₜ+b_{y} [Mathematical Formula 11]

Where Wy and by are the weight and bias parameters of the final output layer.
S002: By a second agent, which utilizes MILP (Mixed Integer Linear Programming), based on the charging demand and at least one of the capacity, grid load, renewable energy, or pricing of the electric vehicle charging stations, to output an energy allocation strategy;
The second agent is responsible for optimizing energy allocation at charging stations, considering factors such as grid load, availability of renewable energy, and energy pricing. This agent employs a Mixed Integer Linear Programming (MILP) model, aiming to determine the optimal energy allocation strategy, ensuring efficient resource utilization while minimizing costs and balancing energy supply and demand;

The mathematical expression of the MILP model is as follows:

Let Eᵢ(t) be the energy allocated to charging station i at time t, and Pi(t) be the energy price at charging station i at time t. The objective is to minimize total energy cost while satisfying demand and meeting energy availability and capacity constraints. The objective function f(xm) is defined as the following mathematical formula 12:

$$f ( {x}_{m} ) = min {\sum }_{t = 1}^{T} {\sum }_{i = 1}^{N} {P}_{i} ( t ) \cdot {E}_{i} ( t ) \qquad [ Mathematical Formula 12 ]$$

Where T represents the total time range, and N represents the number of charging stations.

### Constraints:

Demand constraint: The demand constraint ensures that the energy allocated to each site can satisfy the predicted demand, which is expressed by the following mathematical formula 13:

Eᵢ(t)≥Dᵢ(t),∀i∈{1, . . . , N},∀t∈{1, . . . , T} [Mathematical Formula 13]

Where Dᵢ(t) is the demand predicted by the demand prediction agent for charging station i at time t.

Capacity constraint: The capacity constraint limits that the energy allocated to each site cannot exceed its maximum capacity, as expressed by the following mathematical formula 14:

Eᵢ(t)≤Cᵢ;∀i∈{1, . . . , N},∀t∈{1, . . . , T} [Mathematical Formula 14]

Where Cᵢ is the maximum energy capacity of charging station i.

Grid constraint: The grid constraint ensures that the total allocated energy does not exceed the available energy of the grid at time t, as expressed by the following mathematical formula 15:

$${\sum }_{i = 1}^{N} {E}_{i} ( t ) \leq G ( t ) , ∀ t ∈ \{ 1 , … , T \} \qquad [ Mathematical Formula 15 ]$$

Where G(t) is the total available energy of the grid at time t.

Renewable energy constraint: The renewable energy constraint ensures that a certain proportion of the allocated energy comes from renewable sources. Let Erenew[i][t] be the renewable energy allocated to site i at time t, and ai be the minimum proportion that must come from renewable energy. The renewable energy constraint can be expressed by the following mathematical formula 16:

E_{renew}[i][t]≤αᵢ·Eᵢ(t),∀i∈{1, . . . , N},∀t∈{1, . . . , T} [Mathematical Formula 16]

Binary decision variable constraint: The MILP model includes binary decision variables for handling discrete decisions, such as turning charging stations on or off. Let xi(t) be a binary variable at time t indicating whether charging station i is activated (xi(t)∈{0,1}). When xi(t)=0, site i is not allocated any energy, making the energy allocation strategy satisfy the on/off status of the electric vehicle charging station locations at each time point, and decisions are made through binary decision variables, as expressed in the following mathematical formula 17:

Eᵢ(t)≤xᵢ(t)·Cᵢ,∀i∈{1, . . . , N},∀t∈{1, . . . , T} [Mathematical Formula 17]

In a specific embodiment, the algorithm pseudocode for the second agent based on the MILP optimization model for electric vehicle charging energy management is shown below, which combines demand prediction, energy allocation, and binary decisions, aiming to achieve efficient energy allocation and cost minimization.

### [Second Agent Algorithm]

Energy management using MILP
Input: Predicted charging demand D_{preds}, energy constraints C_{energy}, renewable energy availability E_{renew}, number of sites N, time period T.
Output: Optimized energy allocation Eₒₚₜ[i][t] for site i at time t.
Define decision variables: E[i][t], xᵢ[t].
Define objective function: Minimize total energy cost
Σ_{i,j} C_{energy}[i][t]·E[i][t].
Add constraints:
Demand satisfaction: E[i][t]≥D_{pred}[i][t]∀i,t.
Renewable energy usage: E_{renew}[i][t]≤α[i]·E[i][t].
Capacity constraints.
Use solver to solve MILP problem.
Retrieve optimized energy allocation Eₒₚₜ[i][t].
Return Eₒₚₜ.

S003: Through a third agent, which is configured with an RL (Reinforcement Learning) model, based on the charging demand, the energy allocation strategy, and the locations of the electric vehicle charging stations, to output a location layout plan for the electric vehicle charging stations.

The third agent aims to optimize the physical layout and distribution of charging stations in the city based on predicted demand and the output of the energy management system. The third agent utilizes reinforcement learning models to iteratively improve the layout of charging stations, ensuring efficient coverage, minimizing congestion, and reducing operational costs. The spatial optimization problem is modeled as a Markov Decision Process (MDP), with the objective of learning the optimal layout of charging stations. The RL model of the third agent comprises states, actions, rewards, and policies. The state is defined as a system of the locations of the electric vehicle charging stations, the charging demand, and the energy allocation strategy. The action is defined as adding or removing based on the locations of the electric vehicle charging stations. The reward is defined as at least one of location coverage rate, utilization rate, congestion level, waiting time, and construction cost of the electric vehicle charging stations, and defines at least one reward function, where reducing congestion level and waiting time are positive rewards, while reducing coverage rate and increasing the construction cost are negative rewards. Therefore, in this embodiment, the RL model consists of the following components: state (st), action (at), reward (rt), and policy (π).

State (st): State st=(Dt, Et, Lt) represents the system state at time t, consisting of the following three components:
Dt: Charging demand data.
Et: Energy allocation strategy.
Lt: Current location layout of electric vehicle charging stations.

Action (at): Action at =(l_{new}, lᵣₑₘₒᵥₑ) represents adding a new electric vehicle charging station (location l_{new}) or removing an electric vehicle charging station (location lᵣₑₘₒᵥₑ) at time t. The action space can be divided into discrete or continuous forms based on the grid of possible locations.

Reward (rt): The reward function encourages actions that improve spatial coverage, reduce congestion, and minimize costs. The reward function at time t is defined as shown in the following mathematical formula 18:

rₜ=w₁·Cₜ−w₂·Uₜ−w₃·Pₜ [Mathematical Formula 18]

Where Cₜ is the coverage rate at time t, defined as the proportion of demand points covered by charging stations within a specified distance; Uₜ is the congestion level at time t, with measurement indicators including utilization rate or average waiting time; Pₜ is the cost of maintaining the current charging station layout; w₁, w₂, w₃ are weight parameters that balance different objectives.

Policy π: This defines the strategy for the agent to select actions based on the current state. The policy is updated according to the environment's reward signals. In this embodiment, the RL model employs the Q-learning algorithm to optimize charging station layout and removal strategies.

Q-value update rule: The Q-value function Q(sₜ, aₜ) represents the expected cumulative reward after taking action aₜ in state sₜ and following the optimal policy. The Q-value update rule is defined as shown in the following mathematical formula 19:

$$Q ( {s}_{t} , {a}_{t} ) ← Q ( {s}_{t} , {a}_{t} ) + {α}_{1} [ {r}_{t} + γ {max}_{a} Q ( {s}_{t + 1} , {a}_{t} ) - Q ( {s}_{t} , {a}_{t} ) ] \qquad [ Mathematical Formula 19 ]$$

Where αᵢ is the learning rate; γ is the discount factor used to control the importance of future rewards; sₜ₊₁ is the new state after executing action at.

### Exploration and Exploitation Strategy:

To balance exploration (trying new actions) and exploitation (selecting the best action), the present invention uses an c-greedy strategy, whose expression is shown in the following mathematical formula 20:

$${a}_{t} = \{ \begin{matrix}random action & with probability ϵ \\ arg {max}_{a} Q ( {s}_{t} , a ) & with probability 1 - ϵ\end{matrix} \qquad [ Mathematical Formula 20 ]$$

Regarding the composition of the reward function of the present invention, in one embodiment, its composition is as follows:

Coverage reward (Cₜ): Measures the degree of charging station coverage for demand, defined as the ratio of the number of covered demand points to the total number of demand points (mathematical formula 21).

$${C}_{t} = \frac{Covered Demand Points}{Total Demand Points} \qquad [ Mathematical Formula 21 ]$$

Congestion penalty (Uₜ): Penalizes actions that lead to increased congestion, with measurement indicators including charging station utilization rate or average waiting time (mathematical formula 22).

$${U}_{t} = \frac{1}{N} {\sum }_{i = 1}^{N} Utilization Rate of Station i \qquad [ Mathematical Formula 22 ]$$

Cost penalty (Pₜ): Penalizes the high costs of operating and maintaining charging stations (mathematical formula 23).

$${P}_{t} = {\sum }_{i = 1}^{N} Cost of Station i \qquad [ Mathematical Formula 23 ]$$

The final output of the third agent is defined as iterative update rules based on the reward function to correspondingly output the location layout plan for electric vehicle charging stations, including the construction and removal of electric vehicle charging stations, and ensuring the achievement of the following objectives:

Efficient coverage: Charging station placement maximizes demand coverage.

Minimize congestion: Reduce congestion by balancing charging station loads.

Cost-effectiveness: Reduce network maintenance and operational costs.

The third agent utilizes reinforcement learning to adaptively optimize charging station placement and removal strategies based on continuously changing demand predictions and energy management outputs, ensuring efficient operation of the charging network while minimizing operational costs and congestion. The RL model algorithm pseudocode for the third agent is shown as follows:

### [Third Agent Algorithm]

Input: Current electric vehicle charging station location layout L_{current}, predicted charging demand D_{pred}, congestion constraints C_{ongestions}, number of electric vehicle charging stations N, time period T.
Output: Optimal electric vehicle charging station location layout Lₒₚₜ.
Initialize RL environment:
State: Current station layout L_{current}.
Action: Possible station relocation or addition.
Reward: Based on utilization rate, waiting time, and congestion.
Define reward function:
Positive reward for reducing waiting time and congestion.
Negative reward for underutilized stations.
Select RL algorithm (DQN) and initialize policy.
For each episode.
For each time step in T.
Select action based on policy (move/add station).
Apply action and update station layout Lₜ₊₁.
Observe reward and update policy.
End for loop.
End episode when convergence is reached.
End for loop.
Return output optimal layout Lₒₚₜ.

S004: Through a fourth agent, which uses an RL model to interactively coordinate and balance the outputs of the first agent, the second agent, and the third agent.

The fourth agent primarily coordinates the consensus models among the agents interactively. The interactive coordination agent is a crucial part of the system, responsible for ensuring that the actions and decisions of other agents (demand prediction agent, energy management agent, and spatial optimization agent) remain consistent with the overall system objectives. To achieve this goal, this agent implements a consensus-based distributed optimization model to facilitate coordinated decision-making among agents. The objective of the consensus optimization model is to ensure that each agent's decisions converge to a common consensus while balancing their individual objectives with global system objectives. The fourth agent takes the outputs of the first through third agents as input values and defines a consensus protocol to iteratively adjust and minimize the loss functions of the first through third agents, making the outputs of the first through third agents conform to the consensus protocol, to serve as the output of the fourth agent.

The mathematical definition of the consensus protocol model is as follows: Consensus variable (Zₜ): Zₜ represents the consensus state at time t, reflecting the average decisions of all agents. Agent parameters (θₜᵢ): Each agent i at time t possesses a set of parameters θₜᵢ, which determine its local decision-making process. Learning rate (α): α represents the learning rate used when updating agent parameters. Penalty term (ρ): ρ represents the penalty imposed when an agent's parameters deviate from the consensus. At each time step t, each agent updates its parameters according to the following update rule, as shown in the following mathematical formula 24:

$${θ}_{t + 1}^{i} = {θ}_{t}^{i} - α ∇ {L}_{i} ( {θ}_{t}^{i} ) + ρ ( {z}_{t} - {θ}_{t}^{i} ) \qquad [ Mathematical Formula 24 ]$$

Where ∇Lᵢ(θₜⁱ) is the gradient of agent i's local loss function Lᵢ at time t, Zₜ is the consensus variable at time t, and ρ·(Zₜ−θₜⁱ) is the penalty term for deviating from consensus.

Consensus update rule: The consensus variable Zₜ is updated based on the average decisions of all agents, with the update rule defined as the following mathematical formula 25:

$${z}_{t} = \frac{1}{N} {\sum }_{i = 1}^{N} {θ}_{t + 1}^{i} \qquad [ Mathematical Formula 25 ]$$

Where N is the total number of agents, and θₜ₊₁ⁱ represents the updated parameters of agent i at time t+1.

Objectives and coordination: The fourth agent serves as the interactive coordination agent, with the objective of minimizing the global loss function and ensuring that all agents' decisions converge to a common solution. The global objective is defined as the following mathematical formula 26:

$${min}_{{θ}^{1} , {θ}^{2} , … , {θ}^{N}} {\sum }_{i = 1}^{N} {L}_{i} ( {θ}^{i} ) + λ {\sum }_{i = 1}^{N} {‖ {θ}^{i} - z ‖}^{2} \qquad [ Mathematical Formula 26 ]$$

Where Lᵢ(θⁱ) is the local loss function of agent i; ∥θⁱ−Z∥² is the deviation penalty between agent parameters and the consensus variable; λ is the weight parameter used to balance local loss and consensus penalty.

The loss function Lᵢ(θⁱ) of each agent i is defined according to its specific objectives, for example:
Demand prediction agent: Minimize prediction error.
Energy management agent: Minimize energy allocation costs and grid load imbalance.
Spatial optimization agent: Minimize congestion and layout inefficiency.
Fourth agent coordination process:
The interactive coordination process includes the following steps:
Each agent calculates the gradient ∇Lᵢ(θₜⁱ) based on its local loss function.
Each agent updates its parameters θₜ₊₁ⁱ according to the update rule, minimizing its loss function while maintaining consistency with the consensus.
Update the consensus variable Zₜ to reflect the average decisions of all agents.
Repeat the above process until all agents' decisions converge.
Overall system optimization:

The fourth agent ensures that the decisions of the first through third agents remain consistent, thereby achieving global optimization of electric vehicle charging station layout. The consensus-based distributed optimization model effectively coordinates the actions of all agents, achieving optimal layout and operation of the charging station network while balancing individual objectives with global system objectives. The algorithm pseudocode for the consensus model in the fourth agent is shown as follows in one embodiment.

### [Fourth Agent Algorithm]

Input: Optimized energy allocation strategy Eₒₚₜ, predicted charging demand D_{pred}, optimal electric vehicle charging station location layout plan Lₒₚₜ, number of stations N, time period T.
Output: Consensus regarding energy allocation and electric vehicle charging station locations.
Initialize consensus protocol.
Define global objective: Minimize system cost and congestion.
Begin consensus process:
For each agent (demand, energy, spatial)
Propose solution (Eₒₚₜ, D_{pred}, Lₒₚₜ)
End for loop
Iteratively adjust proposals to reach consensus
For each iteration
If energy allocation satisfies constraints.
Accept proposal.
Else:
Adjust Eₒₚₜ or Lₒₚₜ
End if condition.
End for loop.
Return final consensus regarding Eₒₚₜ, Lₒₚₜ.

In one embodiment, the present invention provides a system for integrating multi-agent reinforcement learning and consensus-based energy management to achieve smart electric vehicle charging station placement, which includes a device implementing the method for integrating multi-agent reinforcement learning and consensus-based energy management to achieve smart electric vehicle charging station placement as described above. The electric vehicle charging stations are respectively connected to the device to receive information and implement the method of the present invention.

In one embodiment, the system for integrating multi-agent reinforcement learning and consensus-based energy management to achieve smart electric vehicle charging station placement comprises:
A first agent 1, which is a hybrid LSTM (Long Short-Term Memory) model and CNN (convolutional neural networks) model, by inputting historical data of at least one electric vehicle charging station to predict temporal and spatial distribution of charging demand;
A second agent 2, which is connected to the first agent 1, the second agent utilizes MILP (Mixed Integer Linear Programming), based on the charging demand and at least one of the capacity, grid load, renewable energy, or pricing of the electric vehicle charging stations, to output an energy allocation strategy;
A third agent 3, which is connected to the first agent 1 and the second agent 2, the third agent is configured with an RL (Reinforcement Learning) model, based on the charging demand, the energy allocation strategy, and the locations of the electric vehicle charging stations, to output a location layout plan for the electric vehicle charging stations; and
A fourth agent 4, which is respectively connected to the first agent 1, the second agent 2, and the third agent 3, the fourth agent 4 uses an RL model to interactively coordinate and balance the outputs of the first agent 1, second agent 2, and third agent 3.

Regarding the implementation of the multi-agent system (MAS) of the present invention, in the multi-agent system (MAS) designed for optimizing electric vehicle charging station layout and operation, each agent plays a unique role in achieving specific optimization objectives:

First agent: Hybrid LSTM-CNN model in the demand prediction agent.

Its implementation begins with collecting diverse datasets, including historical charging demand, weather conditions, traffic patterns, holidays, and other factors that influence demand. Data undergoes preprocessing to ensure data consistency, with steps including data normalization, handling missing or noisy data, and dividing data into training, validation, and test sets. The model combines the advantages of convolutional neural networks (CNN) and long short-term memory networks (LSTM):

CNN layers: Extract important local features from non-time series inputs (such as weather, day of the week, etc.), further processed using ReLU activation functions and pooling layers.

LSTM layers: Capture long-term temporal dependencies from historical demand data.

Fully connected layers: Combine the outputs of CNN and LSTM layers, integrating spatial and temporal features.

The model is trained through backpropagation, using Mean Squared Error (MSE) as the loss function, Adam as the optimizer, and incorporating early stopping mechanisms to prevent overfitting. Model performance is evaluated through metrics such as Root Mean Square Error (RMSE) and Mean Absolute Error (MAE) to ensure the reliability of prediction results. Finally, the trained model predicts the demand for each charging station at different time periods and passes the results to the energy management agent and spatial optimization agent as the basis for further system optimization.

Second agent: MILP model in the energy management agent.

The implementation of the Mixed Integer Linear Programming (MILP) model in the energy management agent focuses on optimizing energy allocation at charging stations, considering grid constraints, availability of renewable energy, and energy pricing.

### [Modeling Process]

Define decision variables representing energy allocation for each charging station in each time period.
Construct objective function aimed at minimizing total energy cost.
Add constraints:
Satisfy predicted demand.
Comply with capacity limitations of charging stations and grid.
Consider allocation proportion of renewable energy.

### [Tools and Solving]

The model is implemented using Python's PuLP tool and introduces binary decision variables to determine the operational status of charging stations. After solving the MILP problem, an optimal energy allocation strategy that balances efficiency and cost is obtained. The results are integrated into the system to guide real-time energy allocation, ensuring smooth operation and achieving sustainable objectives.

Third agent: Reinforcement Learning (RL) model in the spatial optimization agent.

The implementation of the Reinforcement Learning (RL) model in the spatial optimization agent aims to dynamically optimize charging station layout, maximizing demand coverage and minimizing congestion.

### [Environment Modeling]

Model the spatial characteristics of cities or regions, including current charging station locations, traffic patterns, and demand distribution.

### [States and Actions]

State: Captures the spatial configuration of charging stations and demand patterns.

Action: Add or relocate charging station positions.

### [Reward Function]

Design reward functions that balance utilization rate, waiting time, and congestion, encouraging efficient use of charging stations and penalizing excessive congestion or low utilization.

The model employs Deep Q-Network (DQN) algorithm for training, learning optimal strategies through repeated interaction with the simulation environment. Training is based on historical data or simulated demand, exploring various layouts to converge to optimal solutions. After training completion, the model supports real-time adjustment of the charging station network, improving accessibility and optimizing system operational efficiency.

Fourth agent: Consensus model in the interactive coordination agent.

The interactive coordination agent coordinates the decisions of all agents through a consensus model, ensuring system balance and efficient operation.

### [Core Mechanism]

Based on distributed consensus algorithms or consistency algorithms, facilitate agreement among agents on key decisions, including energy allocation strategies from the energy management agent, layout plans from the spatial optimization agent, and prediction results from the demand prediction agent.

### [Global Objectives]

Integrate the decision variables of each agent into a global objective function, uniformly coordinating energy availability, demand satisfaction, and spatial constraints.

### [Information Sharing]

Establish smooth information exchange mechanisms to ensure that all agents share a unified system state, including data such as demand predictions and energy prices.

### [Integration of All Agents]

The integration of all agents in the system is managed through a centralized control mechanism, coordinating their independent operations to ensure optimal system performance.

Demand Prediction Agent (First Agent (Agent 1)): Predicts demand for each charging station in future time intervals, providing input for the energy management agent and spatial optimization agent.

Energy Management Agent (Second Agent (Agent 2)): Optimizes energy allocation based on predicted demand, balancing grid constraints and renewable energy availability, and transmits results to the control center and charging station operators.

Spatial Optimization Agent (Third Agent (Agent 3)): Dynamically optimizes charging station layout using real-time usage data and demand predictions, reducing congestion and improving coverage.

Interactive Coordination Agent (Fourth Agent (Agent 4)): Coordinates the outputs of all agents, integrating energy allocation, spatial configuration, and demand prediction to ensure decision consistency.

All agents are linked through dynamic feedback loops. For example, when the demand prediction agent detects a surge in demand, the energy management agent reallocates energy, the spatial optimization agent adjusts charging station configuration, and the interactive coordination agent ensures these responses remain coordinated. This multi-agent system provides a highly adaptive and efficient solution that effectively manages electric vehicle charging station networks through optimizing demand prediction, energy allocation, and spatial layout, achieving overall collaborative system operation.

### Experimental Example

### [Experimental Environment Setup]

The simulation environment aims to closely resemble real urban areas, specifically including the following elements: electric vehicle charging stations, spatial regions, energy supply, and grid constraints. Based on the urban layout of Palo Alto, California, USA, 60 electric vehicle charging stations were simulated. The area is divided into multiple sub-regions, each with different demand characteristics to represent the heterogeneity of urban demand. The energy mix includes renewable energy sources (such as solar and wind) and non-renewable grid energy, simulating grid limitations and their fluctuation characteristics. Additionally, traffic patterns are simulated based on average hourly vehicle counts and peak/off-peak travel data. Electric vehicle adoption rates and typical charging time data are used to simulate demand peaks (such as morning and evening rush hours). Seasonal and daily fluctuations are also incorporated, reflecting changes in renewable energy supply and their impact on demand patterns.

### [Demand Simulation]

To simulate fluctuating electric vehicle charging demand, the experiment integrated historical demand patterns, demand variability, and external influencing factors:

Data sources: The simulation utilized historical electric vehicle charging transaction data from Palo Alto from 2011 to 2022.

Statistical modeling: Employed moving average methods and time series models to capture daily, weekly, and seasonal trends.

Demand variability: Introduced 10%-30% random fluctuations to simulate real-time demand changes caused by events, weather changes, and traffic peaks.

Special scenarios: Simulated high-demand periods such as public events to test the system's response capability.

### Energy Supply Simulation

Renewable energy contribution: The proportion of renewable energy in total energy supply was set at 30%-50%.

Volatility: Simulated seasonal and temporal fluctuations in renewable energy supply.

Grid constraints: Including grid capacity limitations, peak pricing, and uncertainty in renewable energy supply.

### [Experimental Tools and Implementation]

Simulation tools: Python

SimPy: Used for event-based simulation, creating discrete event simulation environments for interactive coordination agents.

NumPy and Pandas: Used for data processing.

RLlib: Supports reinforcement learning algorithms and multi-agent environments.

Pyomo: Used for solving MILP models in energy management agents.

PyTorch: Used for LSTM-CNN models in demand prediction agents.

Matplotlib and Seaborn: Used for visualizing demand patterns, energy allocation, and performance results.

This experimental setup comprehensively evaluates the adaptability and effectiveness of the proposed multi-agent reinforcement learning model in dynamic urban environments, and verifies its scalability and robustness in optimizing charging station layout and energy allocation.

### [System Performance Evaluation Metrics]

The performance of the multi-agent system of the present invention is evaluated through the following key metrics, with specific definitions and meanings as follows:

### Wait Time (WT):

Definition: The time electric vehicles wait for available charging stations.

Meaning: Wait time is a user-centric metric for measuring system performance. Reducing wait time reflects improved charging station usage efficiency and enhanced user experience. Particularly during peak demand periods, reducing wait time is crucial for improving system performance and user satisfaction.

### Station Utilization Rate (SUR):

Definition: The ratio of actual usage time to total available time of charging stations.

Meaning: Utilization rate measures the usage efficiency of charging infrastructure. Higher utilization rates indicate that charging stations continuously serve users, demonstrating the rationality of charging station site selection. However, excessively high utilization rates may indicate insufficient infrastructure supply, leading to congestion and increased wait times. The objective of the present invention is to achieve optimal balance where charging stations are efficiently utilized but not oversaturated.

### Load Balancing:

Definition: The degree of uniform distribution of energy demand among charging stations and grid nodes.

Meaning: Effective load balancing can reduce pressure on individual charging stations or grid nodes, decrease system failure risks, and improve energy utilization efficiency.

### Spatial Coverage:

Definition: The geographical coverage and accessibility of charging stations within the target area.

Meaning: Spatial coverage ensures reasonable distribution of charging stations, enhances user convenience, reduces user travel time to charging stations, and promotes fairness and strategic layout of charging infrastructure.

These metrics can comprehensively evaluate the performance of the proposed system in dynamic environments, verify its optimization effectiveness in demand prediction, energy allocation, and charging station layout, and ensure the system can adapt to varying urban energy demands and operating conditions.

### Experiment 1: Reinforcement Learning-Based Optimization of Electric Vehicle Charging Station Layout

The Reinforcement Learning (RL) model utilizes the Q-learning algorithm to optimize charging station site selection, relocation, and removal operations. The Q-table generated through the simulation process records the learning values of different actions (i.e., building new, relocating, or removing charging stations) under various states. Table 1 below shows the Q-table for five charging station layouts generated by the RL model in the multi-agent system (MAS). The values in the table represent the expected future cumulative rewards for executing specific actions at given charging stations.

### Q-value Analysis:

Higher Q-values: Indicate that the action can bring higher future cumulative rewards under that state.

Lower (or negative) Q-values: Indicate that the action may lead to poorer results.

TABLE 1

| Electric Vehicle Charging Station | Build | Relocate | Remove |
|---|---|---|---|
| Charging Station 1 | −114.41 | −107.28 | −133.532 |
| Charging Station 2 | −122.508 | −117.57 | −141.444 |
| Charging Station 3 | −115.098 | −109.464 | −134.221 |
| Charging Station 4 | −113.513 | −101.197 | −126.190 |
| Charging Station 5 | −125.142 | −117.126 | −130.985 |

Taking Charging Station 1 as an example, for the “Build” action, the negative Q-value (such as −114.41) indicates that building a new charging station at this location may lead to insufficient demand or low efficiency, resulting in congestion or low utilization. The Q-value for the “Relocate” action (such as −107.28) is closer to zero compared to “Build” or “Remove,” indicating that relocating existing stations can better meet local demand and bring relatively better results. The Q-value for the “Remove” action (such as −133.53) is the most negative, indicating that removing charging stations may lead to service gaps and adversely affect electric vehicle users in the area. Therefore, the RL agent will prioritize actions with higher Q-values. In this example, the optimal action for Charging Station 1 is “Relocate” because its Q-value is the highest among the three options.

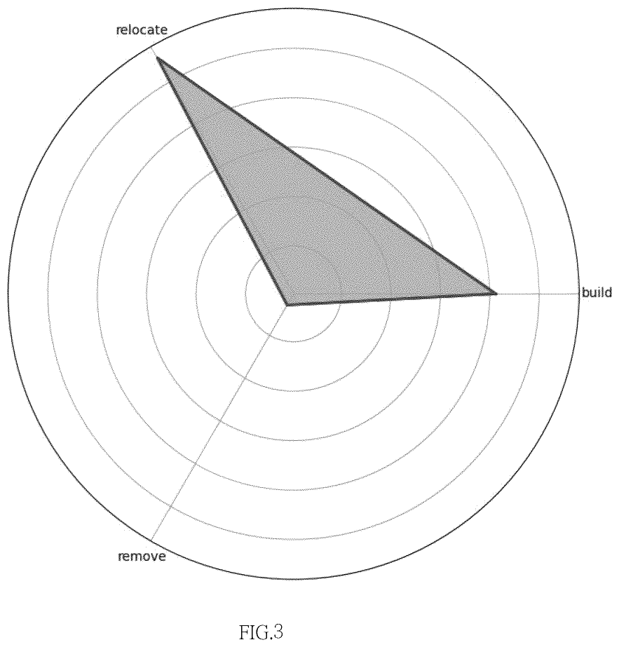

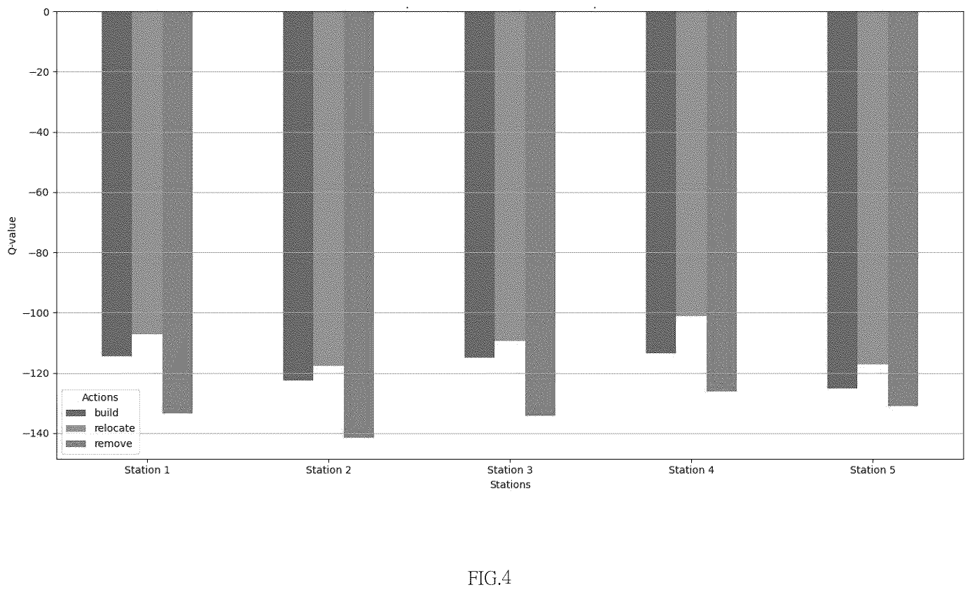

FIG. 3 shows the Q-value radar chart for RL model optimization of Charging Station 1 layout. From the chart, it can be seen that the optimal layout action for Charging Station 1 is “Relocate.” FIG. 4 is a bar chart showing the optimization actions for five electric vehicle charging stations. The results show that the optimal action for all five stations is “Relocate,” meaning that based on the highest Q-value results, all charging station layout optimization actions are unified as relocation.

### [Parameter Influence Analysis]

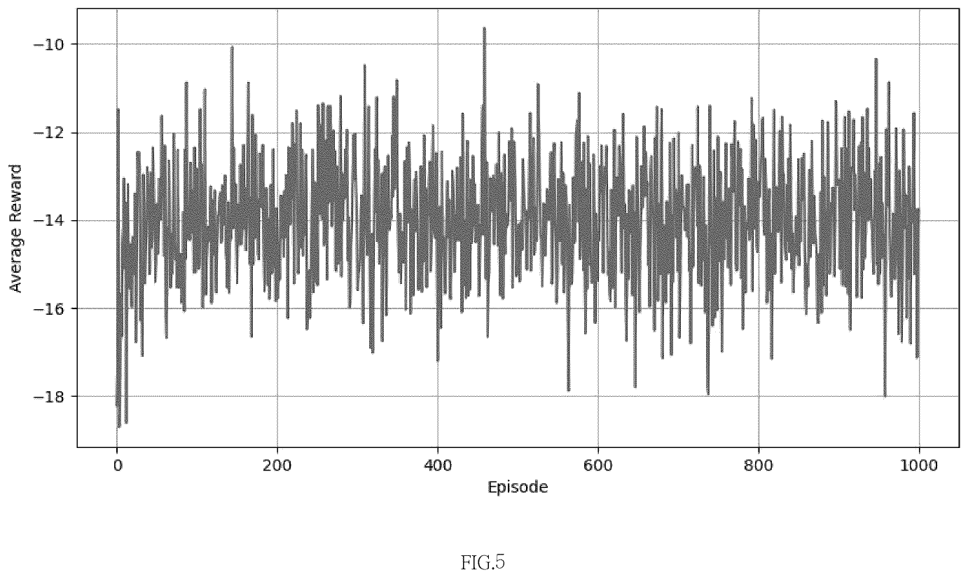

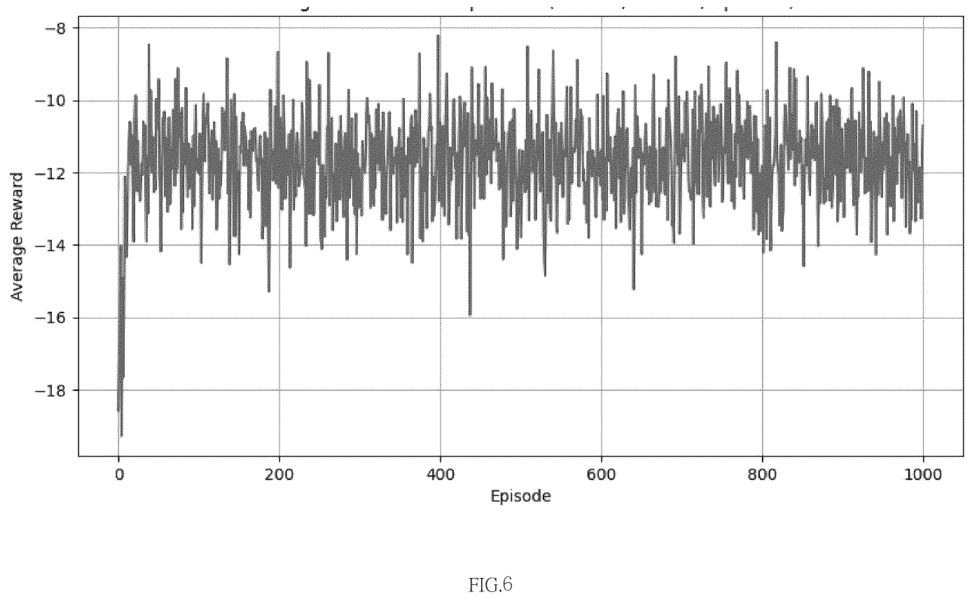

FIGS. 5 and 6 demonstrate the impact of Learning Rate (LR), Discount Factor (DF), and Epsilon (Eps) on RL model performance.

### Parameter Configuration 1 (FIG. 5):

Learning Rate (LR)=0.01 (relatively low, indicating the model makes smaller adjustments to the strategy at each step).

Discount Factor (DF)=0.5 (moderate, indicating moderate emphasis on future rewards).

Exploration Rate (Eps)=0.3 (relatively high exploration rate, indicating more exploration of new actions in the early stages).

Results show that the average reward values fluctuate significantly during training without showing a clear upward trend, indicating unstable model performance.

### Parameter Configuration 2 (FIG. 6):

Learning Rate (LR)=0.1 (moderately increased, allowing the model to adjust strategies more dynamically).

Discount Factor (DF)=0.9 (higher, indicating greater emphasis on future rewards).

Exploration Rate (Eps)=0.1 (lower exploration rate, indicating the model tends more toward exploiting learned optimal strategies).

Under this configuration, the RL model's average reward values tend to stabilize and improve significantly, indicating this configuration performs best in the present invention and is suitable for reinforcement learning tasks in electric vehicle charging station layout.

Experimental Results: From the results of reinforcement learning-based optimization of electric vehicle charging station layout, it can be seen that the proposed reinforcement learning model, after appropriate parameter adjustment, can achieve stable and optimized performance, successfully accomplishing the goal of intelligent charging station layout.

Future Reward Priority: The model focuses on long-term rewards during the optimization process, ensuring that charging station layout dynamically adapts to demand changes over time and effectively balances energy allocation with charging station site selection.

Dynamic Strategy Adjustment: Higher learning rates and discount factors enable the model to quickly learn and adjust strategies, adapting to real-time changing demands and conditions.

Global Optimization: The unified selection of relocation actions demonstrates the RL model's reasonable optimization capability under demand prediction and energy allocation constraints, reducing layout imbalance and congestion issues.

Therefore, Experiment 1 validates the effectiveness of the reinforcement learning model in multi-agent systems and proves the feasibility and robustness of this method for electric vehicle charging station layout optimization and energy allocation.

### Experiment 2: Verification of Consensus-Based Management Agent.

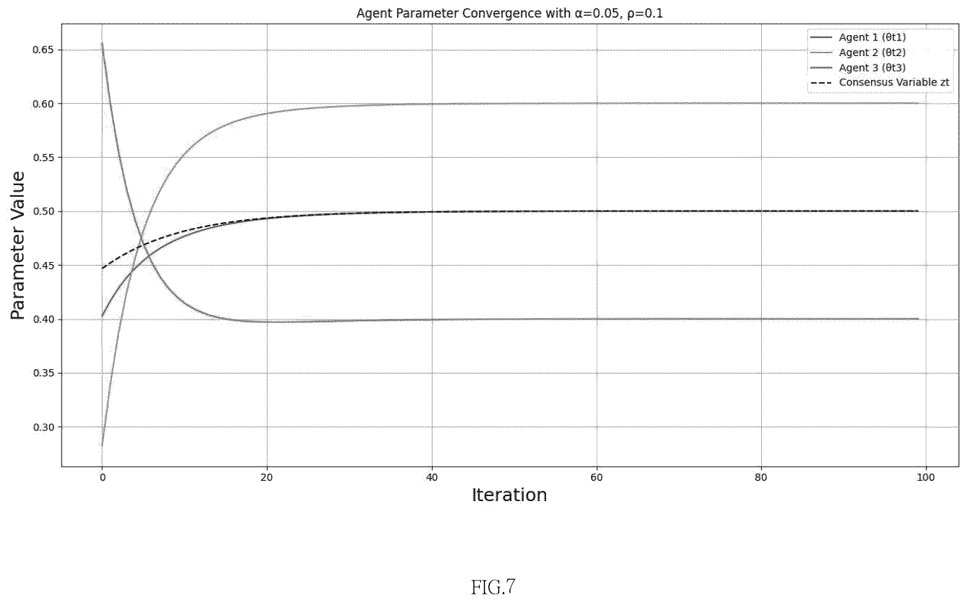

FIG. 7 shows the convergence behavior of parameters for three agents (Agent 1, Agent 2, and Agent 3) and consensus variable zt over 100 iterations. Each agent initially has different parameter values, and over time, these parameters gradually adjust and converge toward the consensus variable. In early iterations, due to initial conditions and the different roles of each agent, the parameters of each agent change along their respective trajectories. However, as iterations progress, the parameters gradually stabilize and converge to the common value defined by consensus variable zt.

This convergence process validates the effectiveness of the consensus-based management agent in synchronizing agent actions and decisions, ultimately achieving collaborative operation among agents. The results demonstrate that the consensus-based management agent successfully facilitates coordination and communication among agents, ensuring that all agents within the system can operate consistently and conform to overall system objectives. By promoting parameter convergence, this agent effectively coordinates decisions for demand prediction, energy management, and spatial optimization, which is crucial for achieving optimal electric vehicle charging station layout and energy allocation.

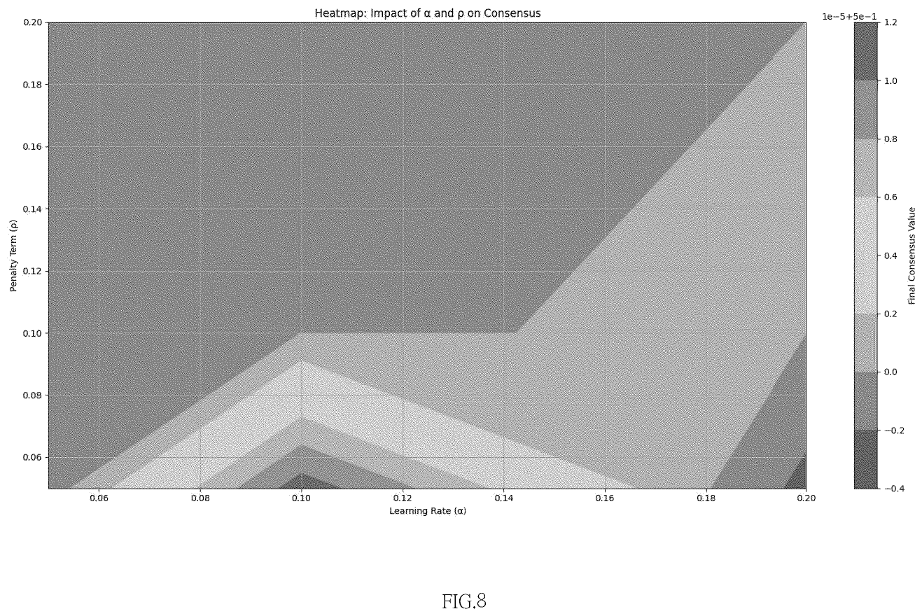

FIG. 8 shows the impact of different combinations of learning rate a and penalty term p on the final consensus value in the consensus-based management model. The color gradient in the figure (red indicating higher consensus values, blue indicating lower consensus values) reveals how these two parameters affect the agents' ability to reach consensus. From FIG. 8, it can be seen that specific combinations of α and ρ can produce more favorable consensus results. For example, combinations of lower learning rates with moderate penalty terms tend to produce higher consensus values, which can be observed from the concentrated red distribution in the lower-left region. Conversely, when both α and ρ are large, consensus values decline, indicating that excessively high learning rates or penalty terms may lead to unstable coordination among agents. This analysis emphasizes the effectiveness and feasibility of the consensus-based management agent in achieving collaborative results among multiple agents with different objectives. Through precise adjustment of α and ρ, the consensus-based management agent can facilitate optimal communication and consistency, ensuring that all agents converge to a unified strategy, thereby achieving global optimization of smart electric vehicle charging station layout.

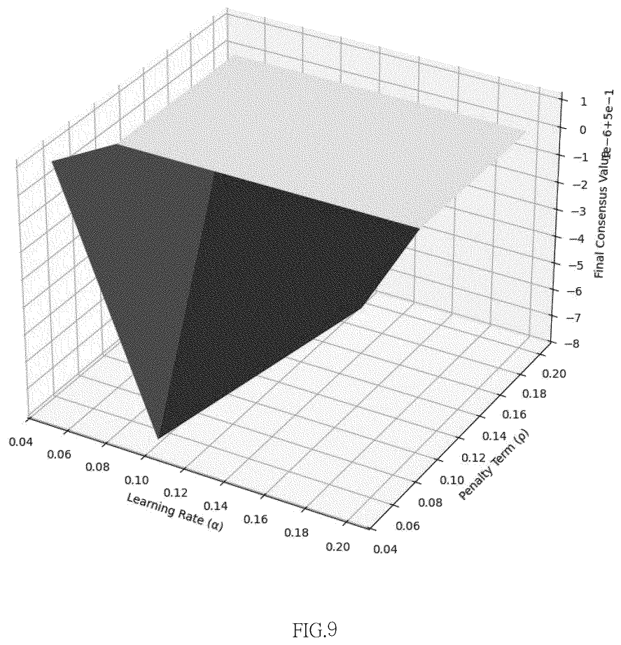

FIG. 9 shows the final consensus values achieved by the consensus-based management agent under different combinations of learning rate a and penalty term ρ. From the figure, it can be seen that consensus values are very sensitive to these two parameters, with certain specific parameter combinations achieving higher consensus values, indicating more effective coordination among agents. In the embodiment, through integrating multi-agent reinforcement learning with consensus-based energy management, this result demonstrates the importance of parameter adjustment for achieving optimal communication and collaboration. For example, specific α and ρ values can achieve higher consensus values, emphasizing that the consensus-based management agent can flexibly adjust strategies according to different learning rates and penalty terms, ensuring that agent objectives remain consistent. This adaptability demonstrates the feasibility and effectiveness of the consensus-based management agent in synchronizing the actions of demand prediction agents, energy management agents, spatial optimization agents, and interactive coordination agents. The results confirm that this consensus model has significant potential in achieving overall system decision coordination, thereby effectively supporting global optimization of smart electric vehicle charging station layout and energy allocation.

### Experiment 3: Reducing Wait Time

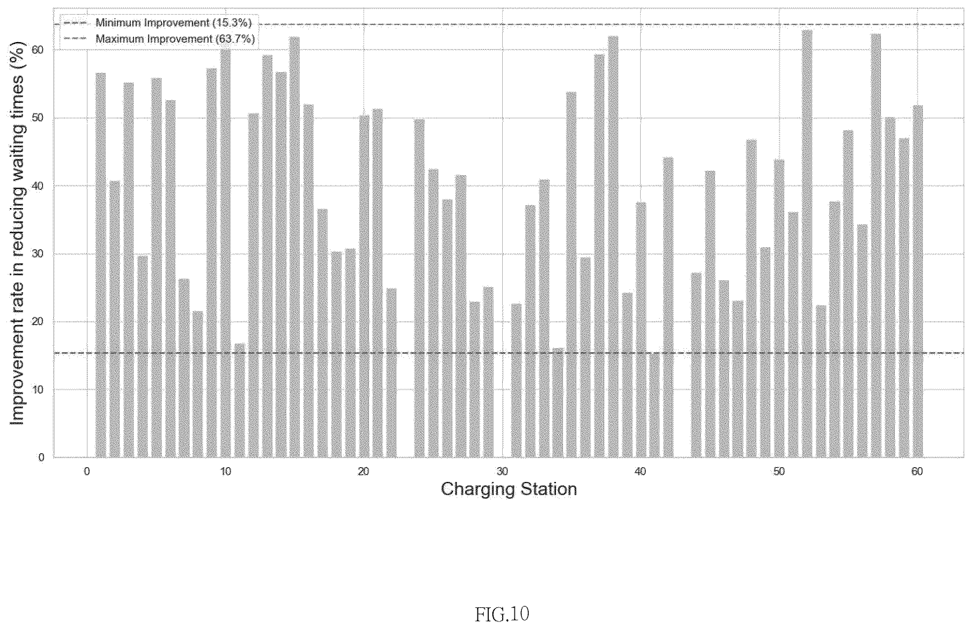

FIG. 10 shows the improvement rates in user wait times for 60 electric vehicle charging stations after optimization. The horizontal axis represents individual charging stations, while the vertical axis shows improvement rates in percentage form. Two reference lines are included in the figure: the red dashed line (15.3%) represents the minimum improvement rate, and the green dashed line (63.7%) represents the maximum observed improvement rate. The results show that all charging stations achieved significant reductions in user wait times, with improvement rates ranging from 15.3% to 63.7%. This consistent and significant improvement indicates that the multi-agent reinforcement learning and consensus-based energy management method proposed by the present invention can effectively optimize charging station layout, thereby minimizing user wait times.

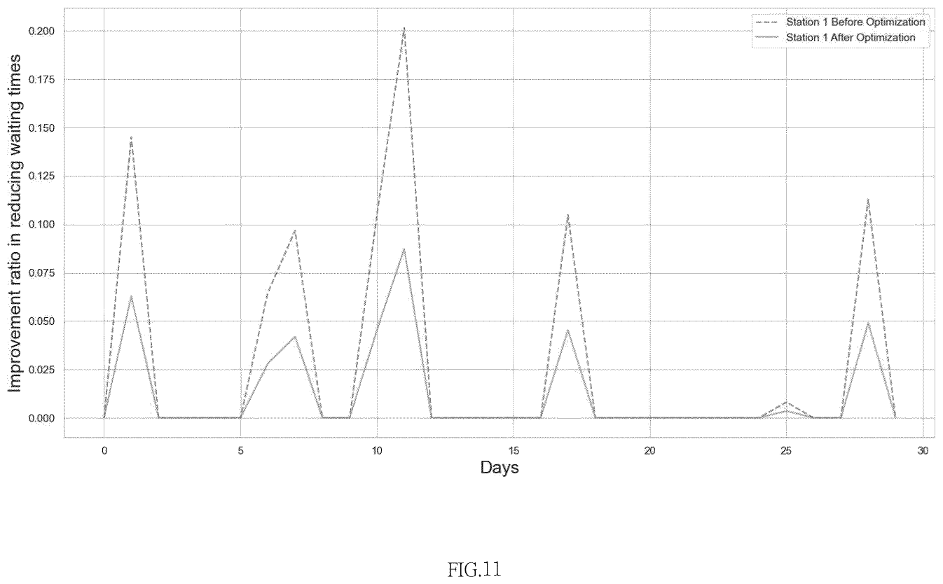

FIG. 11 shows the improvement ratio of wait times for Charging Station 1 before and after optimization. The blue dashed line represents wait times before optimization, while the orange solid line represents wait times within 30 days after optimization. From the figure, it can be clearly seen that this optimization method effectively reduced wait times during peak demand days. Previously occurring wait time peaks during peak hours (with improvement rates reaching approximately 20%) were significantly reduced after optimization. This sustained reduction in wait times demonstrates the effectiveness of the proposed optimization method in managing peak charging demand, further supporting the practicality and effectiveness of the optimization method developed by the present invention.

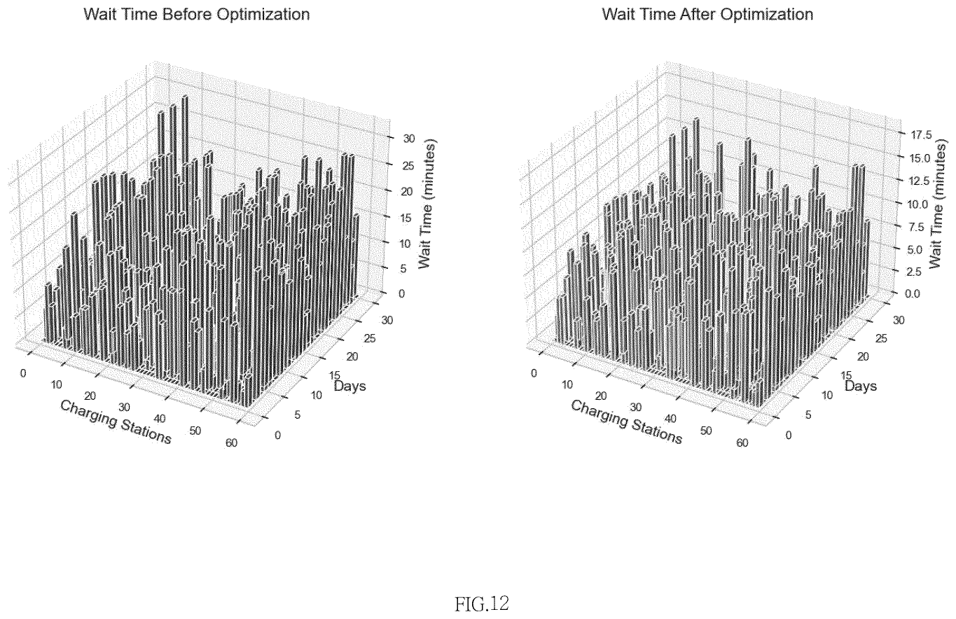

The 3D bar chart combination in FIG. 12 demonstrates the impact of the optimization method proposed by the present invention on reducing wait times for 60 charging stations. The left chart represents average wait times before optimization, while the right chart shows wait times after optimization.

Before optimization: Many charging stations had significantly higher wait times, frequently exceeding 20 minutes.

After optimization: Wait times were significantly reduced at most charging stations, with most values falling below 15 minutes, and some stations even below 10 minutes.

This result shows that both accessibility and usage efficiency of electric vehicle charging stations for users have improved. Given that Level 2 charging typically requires about 4 hours to complete charging, while DC Fast charging requires approximately 30-40 minutes, the reduction in wait times is of significant importance. This improvement indicates that electric vehicle users can find available charging stations more quickly, reduce charging-related delays, and contribute to improving the overall efficiency and effectiveness of charging infrastructure. These results validate the effectiveness of the optimization method proposed by the present invention, demonstrating that through better management of charging station layout and utilization rates, service availability is significantly enhanced. The significant reduction in wait times emphasizes the important value and potential of combining multi-agent reinforcement learning with consensus-based energy management in smart electric vehicle charging system design.

### Experiment 4: Improving Charging Station Utilization Rate

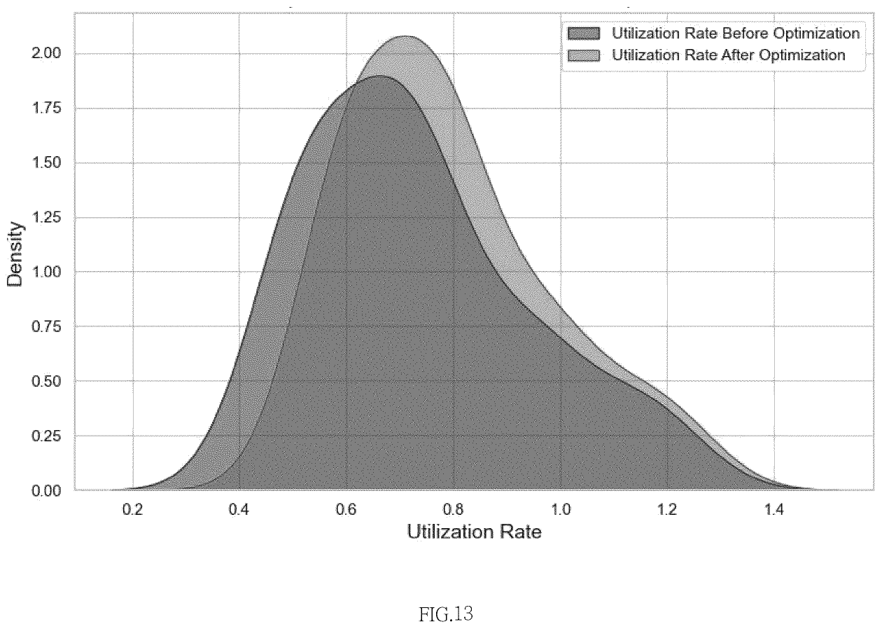

FIG. 13 shows the utilization rate distribution of 60 charging stations in Palo Alto before and after optimization. The blue curve represents the utilization rate distribution before optimization, while the green curve represents the distribution after optimization. The optimized distribution shows a clear rightward shift and concentration in higher utilization rate intervals, indicating that after optimization, more charging stations achieved better usage balance and fell within the optimal utilization rate range. The improvement in average utilization rates and reduction in low utilization phenomena demonstrate the effectiveness of the multi-agent system (MAS) designed by the present invention. This system ensures more efficient allocation of charging station resources to meet user demands through combining reinforcement learning with consensus-based energy management methods, improving overall infrastructure utilization while avoiding charging station overload operation. The results show that the proposed MAS not only optimized charging station layout but also significantly improved charging station usage efficiency, providing a feasible and efficient solution for improving electric vehicle charging infrastructure.

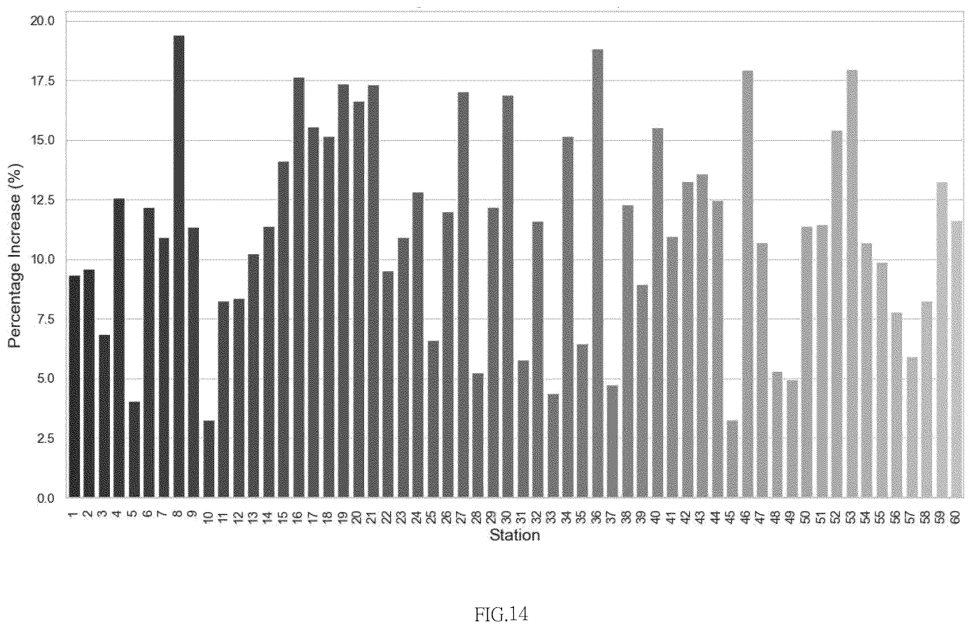

FIG. 14 presents the percentage increase in utilization rates for 60 charging stations after multi-agent system (MAS) optimization. The data shows that all charging stations achieved improved utilization rates, with increases ranging approximately from 2% to 20%. This consistent improvement highlights the effectiveness of MAS in enhancing charging infrastructure distribution and accessibility. Through strategically optimizing charging station locations, MAS achieved more balanced and efficient resource usage, reducing low utilization rates in some areas while avoiding excessive usage in other regions. This approach ultimately created a more accessible and efficient charging network for electric vehicle users, aligning with the goals of reducing wait times and improving service availability. The experimental results further demonstrate the feasibility and effectiveness of MAS in improving utilization rates, supporting the present invention's contribution to sustainable electric vehicle infrastructure management.

### Experiment 5: Improving Load Balancing

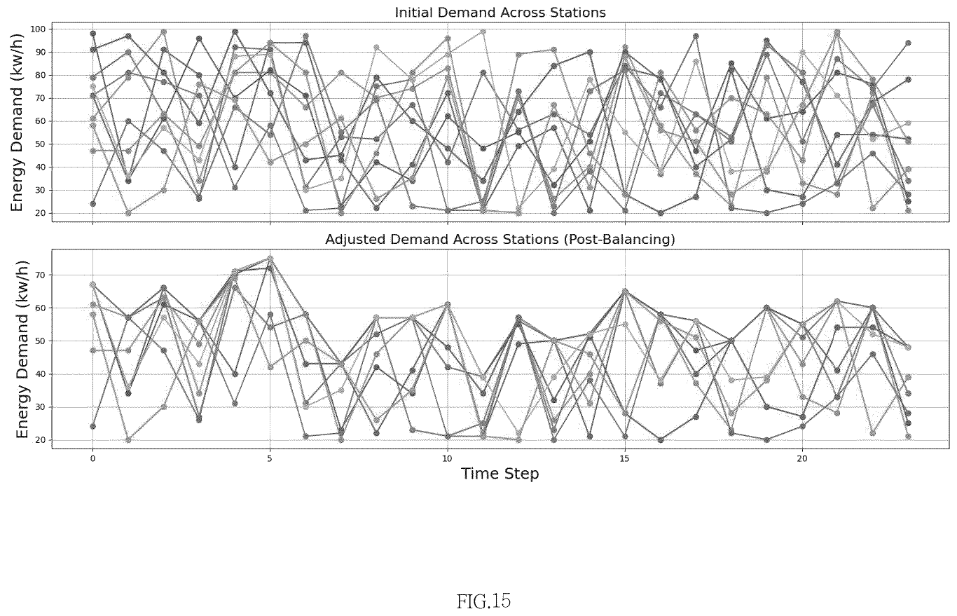

FIG. 15 shows the energy demand changes at multiple charging stations before and after applying load balancing technology. The upper initial demand chart shows greater demand volatility, with some charging stations having significantly higher demand peaks than other sites. The optimized demand chart shows that demand fluctuations are significantly reduced, with energy demand distribution becoming more stable and balanced, indicating that MAS can effectively balance energy loads and reduce excessive demand pressure on individual sites.

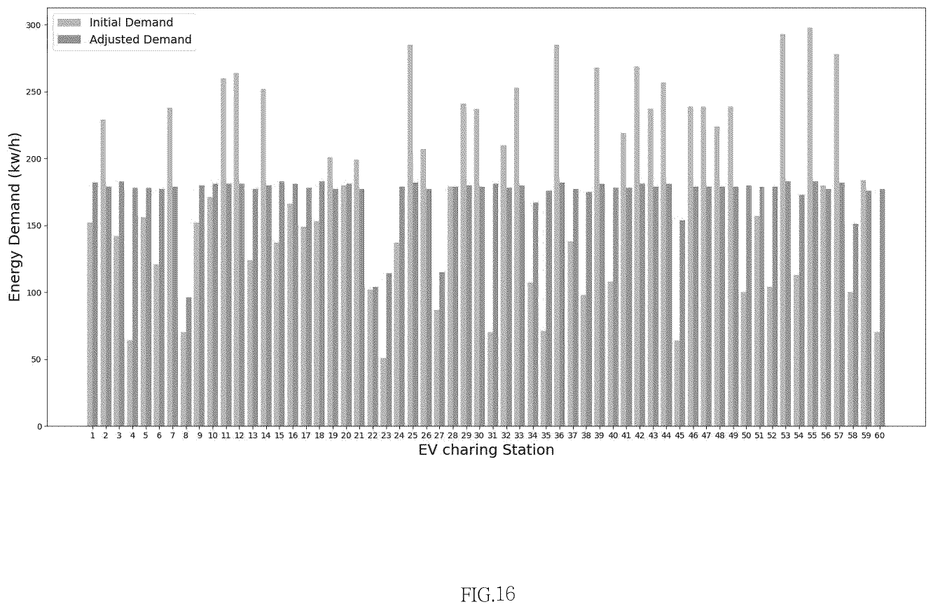

The bar chart in FIG. 16 compares the initial demand with optimized demand distribution for each charging station. In the chart, initial demand (blue) shows large demand differences between sites, with some sites having significantly excessive demand. The optimized demand (red) presents a more uniform distribution, with energy demand at each site approaching the optimal average value. This indicates that MAS successfully achieved balanced demand allocation, effectively reducing system pressure and improving overall efficiency.

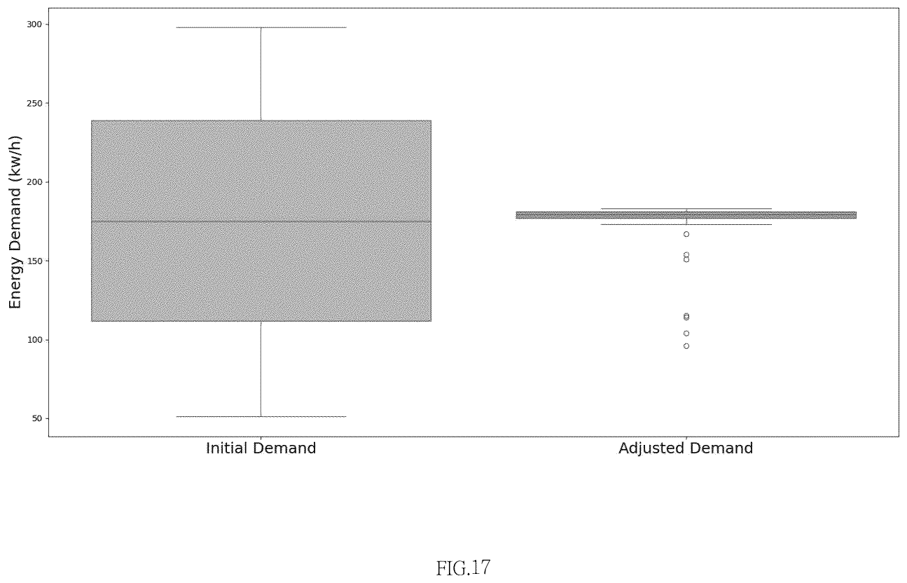

FIG. 17 presents a statistical perspective of demand distribution before and after optimization. The initial demand distribution has a wider range with a higher median, while the optimized demand distribution is more concentrated with a significantly lower median. This significant reduction in demand range indicates the success of MAS in achieving effective load balancing, effectively reducing demand peaks and stabilizing the overall network energy load. Experimental results demonstrate that the MAS designed by the present invention successfully achieved load balancing among charging stations. Through more evenly distributing energy demand, this system effectively reduced pressure on individual sites, improved system reliability, prevented potential failures, and achieved more efficient energy utilization in the electric vehicle charging network.

### Experiment 6: Enhancing Spatial Coverage

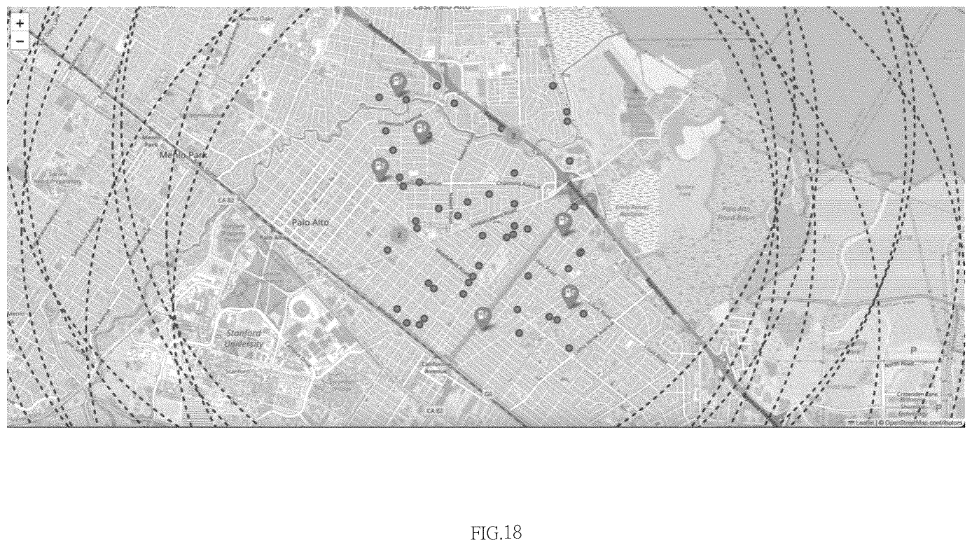

FIG. 18 demonstrates how the multi-agent system (MAS) designed of the present invention improves the spatial distribution of electric vehicle charging stations. The main improvement is reflected in the optimization of charging station layout, maximizing coverage areas and minimizing gaps between sites. The blue concentric circles in the figure represent the service range or influence area of each charging station. After strategic placement, these stations effectively cover high-demand areas while avoiding excessive overlap of service ranges, thereby improving resource efficiency. Additionally, green dots indicate future demand points predicted by the system or locations with potential for additional charging infrastructure. These demand points are located within the coverage areas of charging stations, indicating that MAS successfully positioned charging stations near high-demand areas, enhancing accessibility for electric vehicle users. The rational layout distribution also effectively dispersed charging demand, reducing congestion at individual sites.

As shown in FIG. 18, strategically placed charging stations maximized geographical coverage while minimizing service overlap and gaps between sites. MAS optimized site locations based on demand predictions, ensuring adequate service for high-demand areas and anticipating future growth trends. By balancing spatial optimization with energy management, this system not only improved user convenience but also reduced congestion, thereby promoting a more efficient and scalable electric vehicle charging network.

In summary, the integrated framework provided by the present invention for optimizing electric vehicle (EV) charging station layout addresses key challenges including reducing wait times, balancing energy usage, and optimizing spatial distribution. This framework combines rigorous mathematical models with multi-agent system (MAS) algorithms, achieving dynamic and adaptive optimization objectives through the collaborative action of demand prediction agents, energy management agents, spatial optimization agents, and interactive coordination agents. Based on real charging transaction data and simulated charging grids (including renewable and non-renewable energy), the effectiveness and scalability of the present invention's framework have been validated. Experimental results consistently demonstrate that this framework achieves significant improvements in reducing wait times, achieving energy balance, and optimizing spatial configuration. These results highlight the robustness and adaptability of this method in responding to changes in demand patterns and energy conditions. The present invention provides new contributions to the field of electric vehicle infrastructure optimization, successfully bridging mathematical modeling, multi-agent systems, and energy management, offering practical solutions for policymakers, urban planners, and energy suppliers, contributing to the design of sustainable, efficient, and user-centered electric vehicle charging ecosystems.

While we have shown and described the embodiment in accordance with the present invention, it should be clear to those skilled in the art that further embodiments may be made without departing from the scope of the present invention.

What is claimed is:

1. A method for integrating multi-agent reinforcement learning and consensus-based energy management to achieve electric vehicle charging station placement, which executes the following steps after being loaded by a device, the steps comprising:
through a first agent, which is a hybrid LSTM (Long Short-Term Memory) model and CNN (convolutional neural networks) model, by inputting historical data of at least one electric vehicle charging station to predict temporal and spatial distribution of charging demand;
by a second agent, which utilizes MILP (Mixed Integer Linear Programming), based on the charging demand and at least one of capacity, grid load, renewable energy, or pricing of the electric vehicle charging stations, to output an energy allocation strategy;
through a third agent, which includes an RL (Reinforcement Learning) model, based on the charging demand, the energy allocation strategy, and the locations of the electric vehicle charging stations, to output a location layout plan for the electric vehicle charging stations, and
through a fourth agent, which uses an RL model to interactively coordinate and balance the outputs of the first agent, second agent, and third agent.

2. The method for integrating multi-agent reinforcement learning and consensus-based energy management to achieve smart electric vehicle charging station placement as defined in claim 1, wherein the first agent learns spatial features of the charging demand through the CNN model, and analyzes long-term temporal dependencies based on the spatial features of the charging demand through the LSTM model.

3. The method for integrating multi-agent reinforcement learning and consensus-based energy management to achieve smart electric vehicle charging station placement as defined in claim 1, wherein the second agent is constrained based on the charging demand and maximum demand, capacity, grid load, and renewable energy of the electric vehicle charging stations, and outputs the energy allocation strategy through MILP, and the energy allocation strategy satisfies the on/off status of the electric vehicle charging station locations at each time point.

4. The method for integrating multi-agent reinforcement learning and consensus-based energy management to achieve smart electric vehicle charging station placement as defined in claim 3, wherein the energy allocation strategy is determined through binary decision variables.

5. The method for integrating multi-agent reinforcement learning and consensus-based energy management to achieve smart electric vehicle charging station placement as defined in claim 1, wherein the RL model of the third agent comprises states, actions, rewards, and policies, wherein the state is defined as a system of the locations of the electric vehicle charging stations, the charging demand, and the energy allocation strategy, the action is defined as adding or removing based on the locations of the electric vehicle charging stations, the reward is defined as at least one of location coverage rate, utilization rate, congestion level, waiting time, and construction cost of the electric vehicle charging stations, and defines at least one reward function, where reducing congestion level and waiting time are positive rewards, while reducing the coverage rate and increasing the construction cost are negative rewards, the policy is defined as iterative update rules based on the reward function to correspondingly output the location layout plan for the electric vehicle charging stations.

6. The method for integrating multi-agent reinforcement learning and consensus-based energy management to achieve smart electric vehicle charging station placement as defined in claim 1, wherein the RL model of the fourth agent takes the outputs of the first, second and third agents as input values, and defines a consensus protocol to iteratively adjust and minimize the loss functions of the first, second and third agents, making the outputs of the first, second and third agents conform to the consensus protocol, to serve as the output of the fourth agent.

7. A system for integrating multi-agent reinforcement learning and consensus-based energy management to achieve smart electric vehicle charging station placement, comprising a device that implements the method for integrating multi-agent reinforcement learning and consensus-based energy management to achieve smart electric vehicle charging station placement as described in claim 1, and wherein the electric vehicle charging stations are respectively connected to the device.
